(19) United States
(12) Patent Application Publication
(10) Pub. No.: US 2007/0144763 A1
(43) Pub. Date: Jun. 28, 2007

(54) Communication cable having spacer formed in jacket

(76) Inventors: Chan-Yong Park, Seoul (KR); Jong-Seb Baeck, Daegu (KR); Gi-Joon Nam, Seoul (KR); Woo-Yong Dong, Gyeongsangbuk-do (KR)

Correspondence Address: JONES DAY, 222 EAST 41ST ST, NEW YORK, NY, 10017, US

(21) Appl. No.: 11/635,187

(22) Filed: Dec. 6, 2006

(30) Foreign Application Priority Data
Dec. 16, 2005 (KR) 10-2005-0124308
Jan. 27, 2006 (KR) 10-2006-0008961

(51) Int. Cl. H01B 7/00

(52) U.S. Cl. 174/113 C

(57) ABSTRACT

A communication cable includes at least two pair units in each of which at least two insulation-coated wires are spirally twisted; a separator having a barrier for separating the pair units from each other; an outside jacket surrounding the separator and the pair units separated by the separator; and a plurality of jacket spacers provided to an inner surface of the outside jacket to separate the pair units from outside by a predetermined distance. Thus, the communication cable may prevent crosstalk generated when a high frequency signal is transmitted.

### BACKGROUND OF THE INVENTION

1. Field of the Invention

The present invention relates to a communication cable, and more particularly to a communication cable capable of preventing crosstalk generated when a high frequency signal is transmitted.

2. Description of the Related Art

Generally, a communication cable is used for bulk data transmission using LAN (Local Area Network) or IBS (Intelligent Building System). The communication cable is classified into Category 5, Category 6 and Category 7 depending on its transmission characteristic and also into UTP (Unshielded Twisted Pair) cable, FTP (Foiled Twisted Pair) cable and STP (Shielded Twisted Pair) cable depending on its shield.

An UTP cable generally transmits signals at a rate of about 100 Mbps. In order to enhance the transmission rate of signals through the UTP cable over 1 Gbps, a frequency of about 500 MHz should be used. However, in case a higher frequency is used for high-speed transmission of signals, there occur internal crosstalk between pair units in the UTP cable, attenuation of signal passing along copper, and delay of signals. In order to prevent the internal crosstalk between pair units in the UTP cable, a cable having a shield film between the pair units has been proposed (for example, see Korean Patent No. 0330921).

FIG. 1 is a sectional view showing a conventional UTP cable. Referring to FIG. 1, the conventional UTP cable includes four pair units 1 in each of which two insulation-coated wires 11 are spirally twisted, a cross filler 2 filled in a gap between the pair units 1, and an outside jacket 3 surrounding the pair units 1 and the cross filler 2.

Conventional communication cables mostly transmit data under low frequency environments. Thus, internal crosstalk does not arise, or it may be compensated using DSP (Digital Signal Process) in consideration of factors causing crosstalk.

However, differently from a conventional system using about 80 MHz frequency for transmission of gigabit signals, an improved system designed for signal transmission over gigabit should process the signals in the frequency range of 400˜625 MHz in order to increase the number of signals per unit time. At this time, the internal noise of a cable caused by frequency expansion may be additionally compensated using the degree of twist of the cable pair units. In addition, the internal noise of the cable may be fundamentally compensated using DSP. However, alien crosstalk generated due to the influence of adjacent cables is variously changed depending on external environments of the cable, so it may not be easily compensated using DSP.

In order to solve the above alien crosstalk problem, STP cable or FTP cable in which a shielding member made of a metal film is inserted into a cable jacket is used. However, the STP cable and the FTP cable have an increased weight and a deteriorated flexibility due to the use of a shielding member. In addition, in order to produce STP cable or FTP cable, a process step for inserting a shielding member into a cable should be added, so the cable producing process becomes complicated and difficult. In addition, such cables need an additional construction for grounding, so they are limited to special uses.

In addition, in case a shielding member made of metal film is inserted, attenuation or delay of signals becomes worse since material with a high dielectric constant is applied around copper.

### SUMMARY OF THE INVENTION

The present invention is designed to solve the problems of the prior art, and therefore it is an object of the present invention to provide a communication cable having an improved inner configuration capable of preventing internal crosstalk generated in a cable and alien crosstalk generated between adjacent cables together.

Another object of the invention is to provide a communication cable having an improved internal configuration capable of preventing attenuation and delay of signals, applied by high-frequency signal processing.

In order to accomplish the above object, the present invention provides a communication cable, which includes at least two pair units in each of which at least two insulation-coated wires are spirally twisted; a separator having a barrier for separating the pair units from each other; an outside jacket surrounding the separator and the pair units separated by the separator; and a plurality of jacket spacers provided to an inner surface of the outside jacket to separate the pair units from outside by a predetermined distance.

At least two pair units mentioned above preferably have twisting pitches different from each other.

Preferably, the separator has a radial barrier structure. In this case, the separator preferably has a center portion where barriers are interconnected, and the center portion has a relatively greater thickness than end portions. Selectively, the separator may be twisted in a length direction thereof.

The barrier preferably has a thickness of 0.3 to 1.2 mm.

Preferably, a side of the outside jacket forms a predetermined angle on the basis of the jacket spacers. More preferably, the side of the outside jacket forms a predetermined angle on the basis of the jacket spacers so as to have a quadrangular sectional shape with round edges.

In addition, the jacket spacer has a concave groove, and at least two protrusions adjacent to the concave groove. At this time, ends of the protrusions facing the pair units or the separator are preferably planar or concavely rounded.

Preferably, the protrusions have a height of 0.5 to 2.0 mm. In addition, the jacket spacers preferably have a mounting angle of 30 to 60 degrees.

### BRIEF DESCRIPTION OF THE DRAWINGS

Other objects and aspects of the present invention will become apparent from the following description of embodiments with reference to the accompanying drawing in which:

FIG. 1 is a sectional view showing a conventional UTP (Unshielded Twisted Pair) cable;

FIG. 2 is a sectional view showing a communication cable according to a first embodiment of the present invention;

FIG. 3 is a sectional view showing a communication cable according to a second embodiment of the present invention; and

FIG. 4 is a sectional view showing a communication cable according to a third embodiment of the present invention.

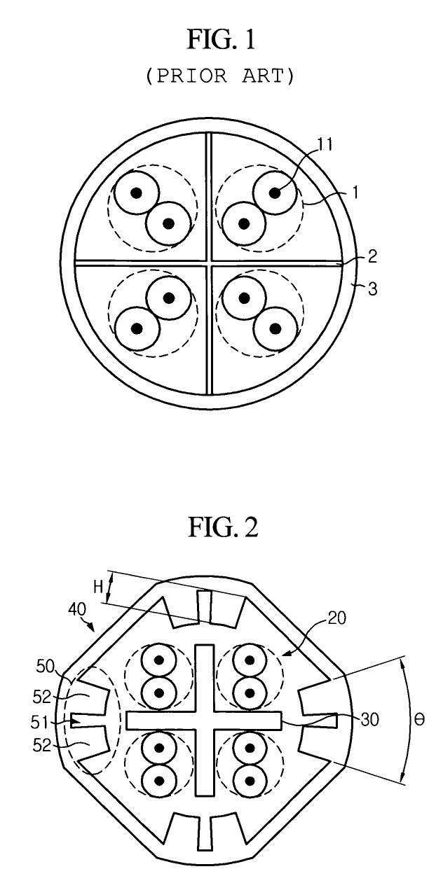

### DESCRIPTION OF THE PREFERRED EMBODIMENT

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a sectional view showing a communication cable according to a first embodiment of the present invention. Referring to FIG. 2, the communication cable of this embodiment includes four pair units 20 in each of which two insulation-coated wires are spirally twisted, a separator 30 for separating and isolating the pair units 20 from each other, an outside jacket 40 surrounding the pair units 20 and the separator 30, and a plurality of jacket spacers 50 provided to an inner surface of the outside jacket 40.

The pair unit 20 is configured so that at least two wires 21, each having an insulator coated on its outer surface, are twisted therein. At this time, in case the plurality of pair units 20 have identical or similar pitches, internal crosstalk is easily generated between the pair units 20 in the cable. Thus, it is preferred to control pitches of the pair units 20 different from each other.

The separator 30 is designed to prevent electromagnetic interference of adjacent pair units 20. For this purpose, the separator 30 has a radial barrier structure in which barriers are crossed by point symmetry on the basis of a center of the cable. In addition, the separator 30 is twisted with a predetermined pitch in a length direction thereof.

Here, the separator 30 is preferably made of dielectric substance such as PE (Polyethylene) or PP (Polypropylene).

In addition, in case the separator 30 has a thickness less than 0.3 mm, it is not easy to produce a high-quality separator. In addition, in case the separator 30 has a thickness greater than 1.2 mm, it is not easy to produce a separator due to its great thickness, and outer diameter and weight of the cable are increased. Thus, the separator 30 preferably has a thickness of 0.3 to 1.2 mm. More preferably, the separator 30 has a thickness of 0.4 to 0.8 mm.

The jacket spacers 50 having a predetermined protruded shape toward the center of the cable are integrally provided to the inner surface of the outside jacket 40. Preferably, the jacket spacer 50 has a trapezoidal protrusion 52.

The jacket spacers 50 make the pair units 20 be separated from the outside jacket 40 by a predetermined distance. As a result, though communication cables become adjacent, the pair units 20 in the cables may be separated from each other by a sufficient distance, thereby preventing crosstalk caused by adjacent cables.

Here, in case the jacket spacer 50 has a height H of 0.5 mm or less, a spacing distance between adjacent cables is not sufficient, so crosstalk generated between cables is not sufficiently prevented. In addition, in case the jacket spacer 50 has a height H of 2.0 mm or more, a spacing distance is sufficient, but much material is unnecessarily consumed for the spacers, thereby increasing outer diameter and weight of the cable. Thus, the jacket spacer 50 preferably has a height of 0.5 to 2.0 mm.

A concave groove 51 is formed in the jacket spacer 50 in a direction from the center of the cable toward the outer jacket 40. The concave groove 51 allows free movement of the protrusion 52 so that tension caused by bending of the cable or external impacts is effectively dispersed. The concave groove 51 also ensures protection of inner structure of the cable.

Furthermore, if a portion of the protrusion 52, which contacts with the inner structure such as the pair units 20 and the separator 30, (hereinafter, referred to as ‘end of the protrusion 52’) is pointed, it may damage the inner structure. Thus, the end of the protrusion 52 is preferably planar or rounded with a predetermined curvature so that it is not pointed.

In addition, in case an angle formed by extension lines of both sides of the jacket spacer 50 (hereinafter, referred to as a mounting angle θ of the jacket spacer) is 30 degrees or less, the pair units 20 may move so easily to be positioned excessively close to the outer jacket 40. In addition, in case the mounting angle θ exceeds 60 degrees, the protrusion 52 provided to the jacket spacer 50 may have a pointed edge. Thus, the mounting angle θ of the jacket spacer is preferably in the range of 30 to 60 degrees. More preferably, the mounting angle θ of the jacket spacer is 35 to 45 degrees.

The outside jacket 40 employed in this embodiment has a side that forms a predetermined angle on the basis of the jacket spacer 50. Accordingly, an overall sectional shape of the communication cable according to the present invention is kept similar to a polygonal shape.

Since the overall sectional shape of the cable is kept similar to a polygonal shape, a side of the outside jacket 40 is formed substantially straight between the adjacent jacket spacers 50. Thus, a relatively less amount of material is consumed to make the outside jacket 40 in comparison to a circular jacket, and thus a weight of the cable becomes lighter.

In addition, since the overall sectional shape of the cable is kept similar to a polygonal shape, when a plurality of cables are installed in a bundle, an installation space can be reduced. As a result, it is possible to reduce an installation space without sacrificing a transmission characteristic.

The outside jacket 40 configured as mentioned above however cannot ensure so sufficient spacing distance to prevent alien crosstalk of the straight side if the cable is contacted with a straight side of another cable installed near to the cable, in spite of the above advantages. However, this problem can be solved during a cable manufacturing process. That is to say, the core that is an aggregate of at least two pair units 20 and the separator 30 is in a twisted state with an aggregation pitch. In addition, since many rollers are used in the manufacturing process, the cable is generally rotated once per 5 m though the outside jacket 40 is not specially rotated. Thus, the cable is as a whole manufactured as if it is twisted with a pitch. Thus, straight sides of adjacent cables are not surface-contacted with each other.

In addition, such a jacket spacer allows the insulation-coated conductor to have a sufficient air layer whose dielectric constant is 1, thereby capable of preventing signal attenuation and delay of the outside jacket out of the insulator, caused by dielectric substance.

Furthermore, the above polygonal shape of the outer jacket gives a sufficient air layer between the outer jacket and the insulation-coated conductors to the maximum, thereby preventing attenuation and delay of signals to the minimum. This polygonal shape gives effects equivalent to or better than the case that attenuation and delay of signals are compensated by just increasing conductors or insulators, and it also gives additional effects of decreasing outer diameter and weight of the entire cable.

Meanwhile, though it has been illustrated that the separator 30 has four barriers and the cable is provided with four jacket spacers 50, the number of barriers and jacket spacers 50 may be changed in various ways depending on the number of pair units 20 mounted in a communication cable.

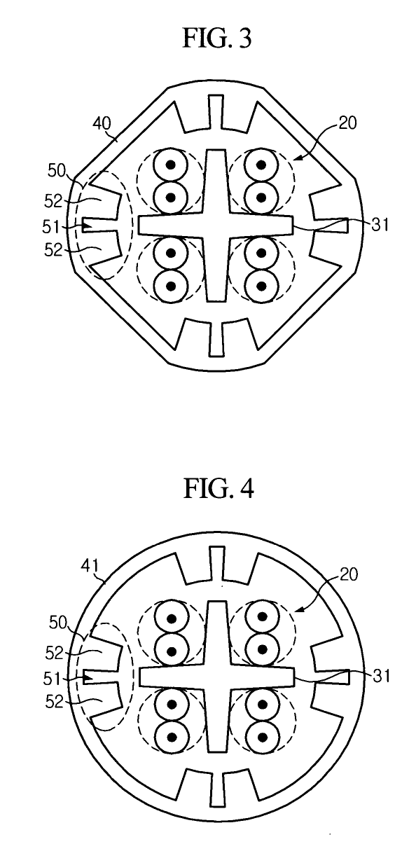

FIG. 3 is a sectional view showing a communication cable according to a second embodiment of the present invention. Referring to FIG. 3 together with FIG. 2, the communication cable of the second embodiment is identical to that of the first embodiment, except that a barrier of the separator 31 has a relatively greater thickness in its center in comparison to its ends. In such a configuration, the separator 31 may more effectively prevent crosstalk generated between pair units 20 positioned in a diagonal direction.

FIG. 4 is a sectional view showing a communication cable according to a third embodiment of the present invention. Referring to FIG. 4 together with FIG. 3, the communication cable of the third embodiment is identical to that of the second embodiment, except that the outer jacket 41 has a looped shape without any angle formed therein, similarly to a conventional one.

As described above, the present invention has been described in detail referring to the accompanying drawings. However, it should be understood that the detailed description and specific embodiments of the invention are given by way of illustration only, not intended to limit the scope of the invention, since various changes and modifications within the spirit and scope of the invention will become apparent to those skilled in the art from this detailed description, so it should be understood that other equivalents and modifications within the spirit and scope of the invention will become apparent to those skilled in the art from this detailed description.

### APPLICABILITY TO THE INDUSTRY

The communication cable according to the present invention gives the following effects.

First, since pair units in a cable can be separated from adjacent cables, alien crosstalk generated during transmission of high-frequency signals can be prevented.

Second, by using the configuration of the present invention, it is possible to realize super-high speed information communication of a gigabyte level using high-frequency signals in the range of 400 to 625 MHz.

Third, the concave groove formed in the jacket spacer gives an effective buffering function against external impacts applied to a cable, thereby keeping a transmission characteristic of the cable.

Fourth, due to the jacket spacers provided to the outer jacket, a transmission characteristic is greatly improved, but an appearance of a cable may be maintained similarly to a conventional one.

Fifth, since the jacket spacers allow a sufficient air layer to be formed between the insulation-coated coppers and the outside jacket, it is possible to minimize attenuation and delay of signals propagated through the coppers, caused by external dielectric substances.

Sixth, since the cable keeps a polygonal sectional shape, a relatively smaller amount of material is consumed in comparison to a cable having a circular section.

Seventh, due to the attenuation and delay of signals by the jacket spacers, it is possible to minimize consumption of conductors and insulators.

Eighth, since the cable keeps a polygonal sectional shape, it is possible to reduce a cable installation space together with keeping excellent transmission characteristic of the cable.

What is claimed is:

1. A communication cable, comprising:
at least two pair units in each of which at least two insulation-coated wires are spirally twisted;
a separator having a barrier for separating the pair units from each other;
an outside jacket surrounding the separator and the pair units separated by the separator; and
a plurality of jacket spacers provided to an inner surface of the outside jacket to separate the pair units from outside by a predetermined distance.

2. The communication cable according to claim 1,
wherein a side of the outside jacket forms a predetermined angle on the basis of the jacket spacers.

3. The communication cable according to claim 2,
wherein the side of the outside jacket forms a predetermined angle on the basis of the jacket spacers so as to have a quadrangular sectional shape with round edges.

4. The communication cable according to claim 1,
wherein the jacket spacer has a concave groove, and at least two protrusions adjacent to the concave groove.

5. The communication cable according to claim 4,
wherein ends of the protrusions facing the pair units or the separator are planar or concavely rounded.

6. The communication cable according to claim 4,
wherein the protrusions have a height of 0.5 to 2.0 mm.

7. The communication cable according to claim 1,
wherein the jacket spacers have a mounting angle of 30 to 60 degrees.

8. The communication cable according to claim 1,
wherein the at least two pair units have twisting pitches different from each other.

9. The communication cable according to claim 1,
wherein the separator has a radial barrier structure.

10. The communication cable according to claim 1,
wherein the separator has a center portion where barriers are interconnected, and the center portion has a relatively greater thickness than end portions.

11. The communication cable according to claim 1,
wherein the separator is twisted in a length direction.

12. The communication cable according to claim 1,
wherein the barrier has a thickness of 0.3 to 1.2 mm.
